(19) United States
(12) Patent Application Publication
(10) Pub. No.: US 2003/0115503 A1
(43) Pub. Date: Jun. 19, 2003

(54) System for enhancing fault tolerance and security of a computing system

(75) Inventors: Judson A. Lehman, Scottsdale, AZ (US); Rajeev Sethia, Chandler, AZ (US)

Correspondence Address: Corporate Patent Counsel, Philips Electronics North America Corporation, 580 White Plains Road, Tarrytown, NY, 10591, US

(73) Assignee: Koninklijke Philips Electronics N.V.

(21) Appl. No.: 10/017,569

(22) Filed: Dec. 14, 2001

(51) Int. Cl. G06F 11/00

(52) U.S. Cl. 714/25; 714/3

(57) ABSTRACT

A system for enhancing fault tolerances and security of a computing system having a system clock through monitoring the computing system for at least one of a series of security attacks and upon detection of security attacks, switching the system from the system clock to a secure clock.

### FIELD OF THE INVENTION

The invention is generally related to the security of a computing system. More specifically, the invention is related to securing application specific integrated circuits (ASICs) which are part of the computing system and which are driven by an external clock.

### BACKGROUND OF THE INVENTION

Computers and computing systems are become increasingly widespread in their integration into daily life. Such systems are used in a wide range of applications and in products ranging from household appliances to personal communication devices such as cellular telephones and handheld planners. One particular, and growing, use of such technology is in the area of monetary transactions.

For example, rather than cash or checks, many people carry a credit or debit card which is associated with an account and which includes an encoded magnetic strip. This magnetic strip contains cardholder information associated with the cardholder account. In use, the cardholder presents the card to vendors for purposes of accessing the cardholder's account, such as to pay for an item or services. The vendor passes the card through a card-reading machine which reads the information off of the encoded magnetic strip and uses that information to complete the transaction.

Driving the automation and use of computing systems in monetary transactions and other applications have been the advancements made in the area of integrated circuit technology. Integrated circuit technology has advanced a great deal over the last several decades to the point where cost and availability have allowed automation to be readily implemented into a large number of applications and systems. Today's integrated circuits contain thousands of transistors forming hundreds of logic gates, and can therefore be readily configured and tailored for a variety of different applications and functions. As such, integrated circuit manufacturers now provide what are referred to as application specific integrated circuits (ASICs).

Within monetary applications and systems, ASIC devices are used to read the necessary information from the magnetic strip of credit and debit cards. Once the information is read, the ASIC is further operable for transmitting the information to access the cardholder's account and further process the transaction so the vendor receives payment. As such, the ASIC devices of such systems are part of the “brains” behind the operation of the systems and are therefore privy to the sensitive account information of the cardholder.

As might be expected, where monetary transactions occur, a criminal element has followed. In particular, in credit and debit card transactions involving card reading machines, illegal attempts are made to determine the sensitive information of the cardholder account so that the account may be illegally accessed to obtain money therefrom or otherwise use the purchasing power of the account. Oftentimes, such illegal efforts are focused on the operation of the ASIC devices in these systems. ASIC devices have certain operational characteristics that have been taken advantage of in attempts to access account information.

More specifically, ASIC devices operate similar to most integrated circuits by using an external clock signal for stepping sequentially through the operational routines which make the ASIC devices perform their functions. Thus, ASIC devices are designed to run off a clock which is operating at a specific frequency. However, most ASIC devices will still operate when they are coupled to a clock with a somewhat higher or lower clock frequency than the clock frequency at which the ASIC devices were originally designed to operate. It has been determined that by applying an “over-frequency” or “under-frequency” clock signal which steps through the operations within the ASIC device, it is possible to ascertain the functionality of the ASIC devices by such manipulation. Furthermore, it is also possible to retrieve data associated with previous transactions conducted by the ASIC device. Therefore, it is possible for an individual to obtain information of another person's account for illegal purposes by manipulating the clock signal of the ASIC device. As such, monetary transactions using card reading machines are often somewhat “unsecure” due to the operational characteristics of the ASIC devices involved in those machines.

Therefore, a need exists for a more secure computing system, and particularly for a more secure system for use in conducting monetary transactions.

More specifically, a need exists in the art for preventing over-frequency or under-frequency clocking of an ASIC device used to ascertain its operation in order to prevent procurement of sensitive data, such as associated with previous financial transactions.

### SUMMARY OF THE INVENTION

The invention addresses these and other problems associated with the prior art by providing an apparatus, program product, and method that prevents illegal access of a system through an application specific integrated circuit (ASIC) to ascertain its operation while preventing procurement of data contained therein. By doing so, a secure environment is provided. Consequently, people are more likely to use application specific integrated circuits when conducting monetary transactions.

In one specific embodiment of the invention, the system clock of the ASIC is monitored. Other conditions might also be monitored. In one embodiment, two clock monitors provide an integrated security solution to protect against clock security attacks. Each clock monitor includes clock monitoring circuitry and a secure clock. Each of the individual clock monitors are integrated together to provide a security mechanism that enhances the overall protection through redundancy. In one embodiment, the clock monitors monitor the clock input to the ASIC for an over-frequency or under-frequency clock signal. Should an over-frequency or under-frequency clock or other security attack be presented at the input to the ASIC, one of the clock monitors reports an alarm signal to the system clock which then switches to a secure clock and uses the respective secure clock associated with that clock monitor rather than the conventional external clock input. The redundant clock monitors ensure that security is maintained should one of the clock monitors be disabled.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

The accompanying drawings, which are incorporated in and constitute a part of this specification, illustrate embodiments of the invention and, together with a general description of the invention given below, serve to explain the principles of the invention.

FIG. 1 is a block diagram of a system incorporating an embodiment of the present invention.

FIG. 2 is a functional block diagram of a clock functioning in accordance with the principals of the present invention.

FIG. 3 is a circuit diagram of one embodiment of the clock function illustrated in the system shown in FIGS. 1 and 2.

FIG. 4 is a circuit diagram of one embodiment of a negative edge switch utilized in the system shown in FIGS. 1, 2 and 3.

FIG. 5A is a portion of a circuit diagram of one embodiment of an oscillator clock multiplexor utilized in the system shown in FIGS. 1, 2 and 3.

FIG. 5B is a another portion of a circuit diagram of a multiplexor utilized in the system shown in FIGS. 1, 2 and 3.

FIG. 6 is a circuit diagram of one embodiment of an secure clock selector utilized in the system shown in FIGS. 1, 2 and 3.

FIG. 7 is a circuit diagram of one embodiment of an system clock selector utilized in the system shown in FIGS. 1, 2 and 3.

### DETAILED DESCRIPTION OF EMBODIMENTS OF THE INVENTION

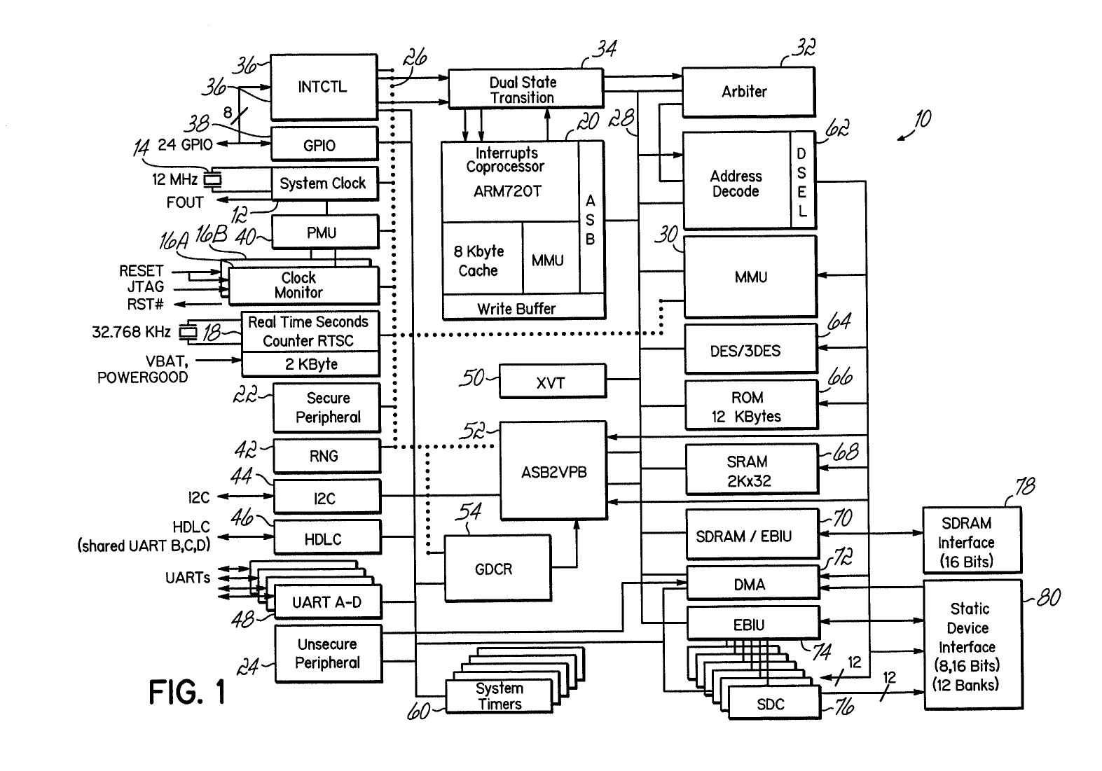

Turning to the drawings, wherein like numbers denote like parts throughout several views, FIG. 1 illustrates a block diagram of one possible application specific integrated circuit device (ASIC) 10 incorporating an embodiment of the present invention. The ASIC 10 shown is for use as a security processor for high speed cryptographic applications in which sensitive data, such as financial account data, is protected from external exposure. The embodiment of the ASIC 10 shown in the Figures is composed of commercially available products from Philips Semiconductors; however, one skilled in the art will recognize that other configurations of similar components, executing similar commands, could be used to provide the same or similar functionality in a variety of applications. Therefore, the ASIC environment supporting the invention may vary from that shown in the embodiments discussed.

The ASIC 10, as shown in FIG. 1, is based on a secure architecture which can be used in many applications including financial applications. The ASIC 10 provides interconnection with devices external to the ASIC 10 through high level data link controller (HDLC) 46, a plurality of Philips Semiconductors' 16550 UARTS (UART A-D) 48 and Philips Semiconductors' I²C port (I2C) 44. Other interconnection schemes may be utilized with the invention that are different from that disclosed in this embodiment. The system shown may also be customized by removing or adding peripherals which provide additional interconnection with the processor 20. This is represented in FIG. 1 by the inclusion of secure peripheral 22 and unsecure peripheral 24. Examples of secure peripheral and unsecure peripherals might be a keypad and a tape printer for credit card transactions.

As shown, ASIC 10 includes an embedded processor 20, read only memory (ROM) 66, internal static random access memory (SRAM) 68, an SRAM controller (SDRAM/EBIU) 70, a plurality of static device controllers (SDC) 76, an interrupt controller (INTCL) 36, an internal phase locked loop within a system clock 12, a plurality of UARTS (UART A-D) 48, a real time seconds counter (RTSC) 18, a plurality of system timers (systems timers) 60, a HDL controller (HDLC) 46, I²C port controller (I2C) 44, secure peripheral 22, unsecure peripheral 24, and general purpose input/output (GPIO) 38. Direct memory access (DMA) 72 support for external devices is also provided. In addition, a system clock 12, a crystal oscillator 14, a power management unit (PMU) 40, a dual state transition logic 34, an arbiter 32, an address decoder including a device selector (DSEL) 62, a bridge between the advanced system bus (ASB) 28 subsystem and VLSI peripheral bus (VPB) subsystem 26 (ASB2VPB) 52, and a global configuration device register (GDCR) 54 are provided. An electronic bus interface unit (EBIU) 74 for a static device interface 80 and a synchronous dynamic random access memory (SDRAM) interface 78 coupled to the SRAM controller SDRAM/EBIU 70 are provided as well.

As is also shown, the embodiment uses a commercially available Philips Semiconductors' ARM720T as the embedded processor 20. The processor includes, but is not limited to, cache memory, such as an 8 k-Byte Cache, a memory management unit (MMU), a write buffer and an advanced system bus (ASB) interface for operation of the processor.

Various of the components noted for the ASIC 10 are typical to an ASIC structure which may or may not include all such noted components or may include more components. The present invention is directed to secure operation of the system clock 12 for an ASIC device or other device as provided by a plurality of clock monitors 16 as discussed in greater detail herein below.

The processor 20 is interfaced to various of the foregoing devices through an internal bus structure which utilizes either an advanced system bus (ASB) subsystem 28 and/or a very large scale integrated (VLSI) peripheral bus (VPB) subsystem 26. The ASB subsystem 28 provides connectivity between a secure arbiter. an address decoder, interfaces to memory which is external to the ASIC, and bridges to other buses within the ASIC. As shown in FIG. 1, this functionality is provided by secure arbiter 32, an address decoder 62, an exception vector table 50, a memory management unit (MMU) 30, triple date encryption standard engine (DES/3DES) 64, read only memory (ROM) 66, static random access memory (SRAM) 68, static memory controllers (SDRAM/EBIU) 70, and direct memory access controller (DMA) 72. In operation, the ASB subsystem 28 generally has two states: secure and unsecure. The state of the ASB 28 depends on the controller within a given device which is granted control of the bus by the processor 20. Thus, the ASB provides both secure and unsecure interconnection between both internal and external devices and the processor 20.

The VPB subsystem 26 consists of a bridge between the ASB subsystem 28 and VPB subsystem 26 (ASB2VPB) 52, a plurality of clock monitors 16, which will be described in more detail hereinafter, an interrupt controller (INTCTL) 36, a plurality of system timers 60, a real time seconds counter (RSTC) 18, a secure peripheral 22 such as a keypad, a plurality of UARTS (UART A-D) 48 which provided connection for devices such as a modem, a high level data link controller (HDCL) 46, a Philips I²C bus interface (12C) 44, an unsecure peripheral 24 such as a printer, general purpose input/output (GPIO) 38, a random number generator (RNG) 42, a global configuration device register (GDCR) 54, power management unit (PMU) 40, and a system clock 12, which will also be described in more detail hereinafter. The VPB subsystem 26 generally two states: secure and unsecure. Thus, the state of the VPB subsystem 26 also depends on the controller within a given device grant control of the bus.

Using the devices selected, the states available for the buses used and the architecture inherent in the structure of the ASIC 10, a method of both secure and unsecure communication between various devices and the processor is provided. For example, the processor 20 could communicate with a keyboard and a tape printer in a monetary transaction using a credit card in a secure/unsecure fashion, as previously mentioned. Thus, the ASIC 10 also provides a number of security features in addition to the features provided by aspects of the invention.

While the architecture of the ASIC 10 provides some security, the ASIC 10 is still susceptible to a number of common security attacks. For example, the security of transactions conducted by the ASIC 10 may still provide information about internal states via over-frequency or under-frequency clocking. The present invention addresses this as well as other concerns by providing a plurality of clock monitors 16 and a system clock to protect the ASIC 10 against a number of common security attacks. More particularly, the embodiment of the present invention shown in the disclosed embodiment and the remaining Figures is directed to security attacks which include over-frequency or under-frequency clocking of the ASIC 10. However, one skilled in the art will recognize that the present invention could be readily adapted to other types of security attacks wherein it is desirable to switch to a secure clock.

As previously mentioned, a clock is used to step the ASIC 10 through the operational routines which make the ASIC 10 perform its functions. By applying an over-frequency or under-frequency clock signal, confidential data associated with transactions conducted using the ASIC may be ascertained. The present invention may be directed to thwarting the illegal access of secure and confidential financial and account information from the ASIC 10. To prevent the ASIC 10 from being over-frequency or under-frequency clocked, high frequency and low frequency monitoring is provided within a plurality of clock monitors 16 in accordance with this particular embodiment of the invention. Although high frequency and low frequency monitoring are provided as part of this particular embodiment of the present invention, a host of other protective features might also be incorporated into the clock monitors 16, as will be appreciated by one of ordinary skill in the art.

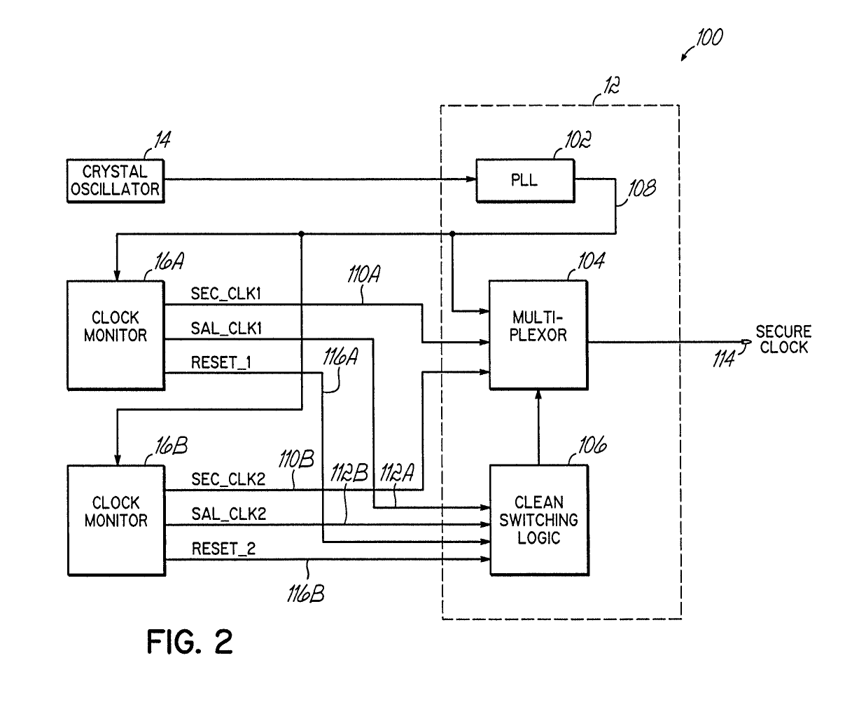

In a security attack in which an ASIC is over-frequency or under-frequency clocked, a person observes the operation of the ASIC, noting the various outputs of the ASIC in response to over-frequency or under-frequency clocking, to ascertain the operation of the ASIC. Turning now to the particulars of the over-frequency and under-frequency detection features of the invention and the ASIC 10. FIG. 2 shows a functional block diagram of certain portions of FIG. 1 which illustrate aspects of the present invention. As shown in FIG. 2, a crystal oscillator 14, along with two clock monitors 16A, 16B, and a system clock 12, make up what will be referred to hereinafter as clock switching circuitry or the clock switch 100. The system clock 12 further includes a phase locked loop (PLL) 102, a multiplexor 104 and clean switching logic 106.

The clock switch 100 functions as follows. A crystal oscillator 14 resonates at a fundamental frequency which is applied to a PLL 102, within the system clock 12, which generates a system clock signal 108 therefrom. The system clock signal 108 is applied to a multiplexor 104, also within the system clock 12, as well as each clock monitor 16A, 16B. Each clock monitor 16A, 16B includes a secure clock which generates a secure clock signal SEC_CLK1 (110A), SEC_CLK2 (110B), respectively, that are also applied to the multiplexor 104, within the system clock 12. Each clock monitor 16A, 16B contains circuitry which is configured to monitor the system clock signal 108 for over-frequency and under-frequency conditions based on parameters set within each clock monitor.

Should neither of the clock monitors 16A, 16B detect an over-frequency or under-frequency condition of the clock signal, the multiplexor outputs the system clock signal 108 as the secure clock 114 that is then used by the processor 20 within the ASIC 10. However, if an over-frequency or under-frequency condition is detected, by one or both of the clock monitors 16A, 16B, the clock monitors 16A, 16B assert a security assurance logic clock signal (SAL_CLK1, SAL_CLK2) 112A, 112B, respectively, to clean switching logic 106 which in turn causes the multiplexor 104 to switch from outputting the system clock signal 108 to outputting the respective secure clock SEC_CLK1 (110A), SEC_CLK2 (110B) for that clock monitor 16A, 16B which detected the over-frequency or under-frequency condition first. In the event that both clock monitors detect the over-frequency or under-frequency condition simultaneously, the clean switching logic 106 cause the secure clock signal, SEC_CLK1 (110A) from clock monitor 16A to be output as the system clock signal 114. Once the clock monitors 16A, 16B determine that an over-frequency or under-frequency condition no longer exists, the secure clock signal 114 is switched back to being the system clock signal 108.

The reset signals RESET_1 (116A), RESET_2 (116B) generated from within the respective clock monitors 16A, 16B are for providing a known logic condition upon power being applied to the clock switch 100. This is accomplished within the clock switch when the reset signals RESET_1 (116A), RESET_2 (116B) are not asserted.

The clean switching logic 106 is provided to accommodate varying clock requirements of the devices driven by the secure clock 114 when switching between the system clock signal 108 and the secure clock signals, SEC_CLK1 (110A), SEC_CLK2 (110B) is generated within the clock monitors 16A, 16B. For purposes of the present invention, switching is considered “clean” if the clock signal 114 meets the following two criteria. First, the clock signal 114 must not have any “glitches” or short transitions that do not cross the logic threshold from either a high-to-low state or low-to-high state. Second, when the clock signal 114 transitions to the low state, the clock signal 114 must remain low for a prescribed amount of time (low-time). Similarly, when the clock signal 114 transitions to the high state, it must remain high for a prescribed amount of time (high time). Low times and high times have minimums and maximums to limit the upper and lower frequency of the clock signal 114. Further, the multiplexor 104 described in this patent is not generally intended for use where a constant clock duty cycle must be maintained. This is because when switching between clocks, the clean switching logic 106 waits until the clock that is to be switched from goes low and then switches to the subsequent clock just after it has gone low, as will be described in more detail in the Figures hereinafter. This results in a composite low time that is generally longer than that of a single clock. Again, the logic described in the illustrated embodiment is specifically selected and adapted to be used with a Philips Semiconductors' ARM720T processor 20. The clean switching logic 106 used could be readily adapted to work with a variety of other devices as well, in accordance with the principles of the invention.

Also, one of ordinary skill in the art will readily recognize that this is but one possible configuration for an implementation of a clock switch feature of the invention. One of ordinary skill in the art will further recognize that each clock monitor could be configured to monitor for any fault and security attack criteria using commonly available circuits, rather than just over-frequency and under-frequency monitoring as described in one embodiment. In addition, one of ordinary skill in the art will also readily recognize that additional clock monitors could be used and that this particular embodiment of the present invention wherein two clock monitors provide redundancy could be expanded to include additional clock monitors for further redundant operation when accompanied by additional clean switching logic and multiplexing. Finally, one of ordinary skill in the art will recognize that the clean switching logic could also be readily adapted to function with a variety of devices or processors having a variety of clock requirements.

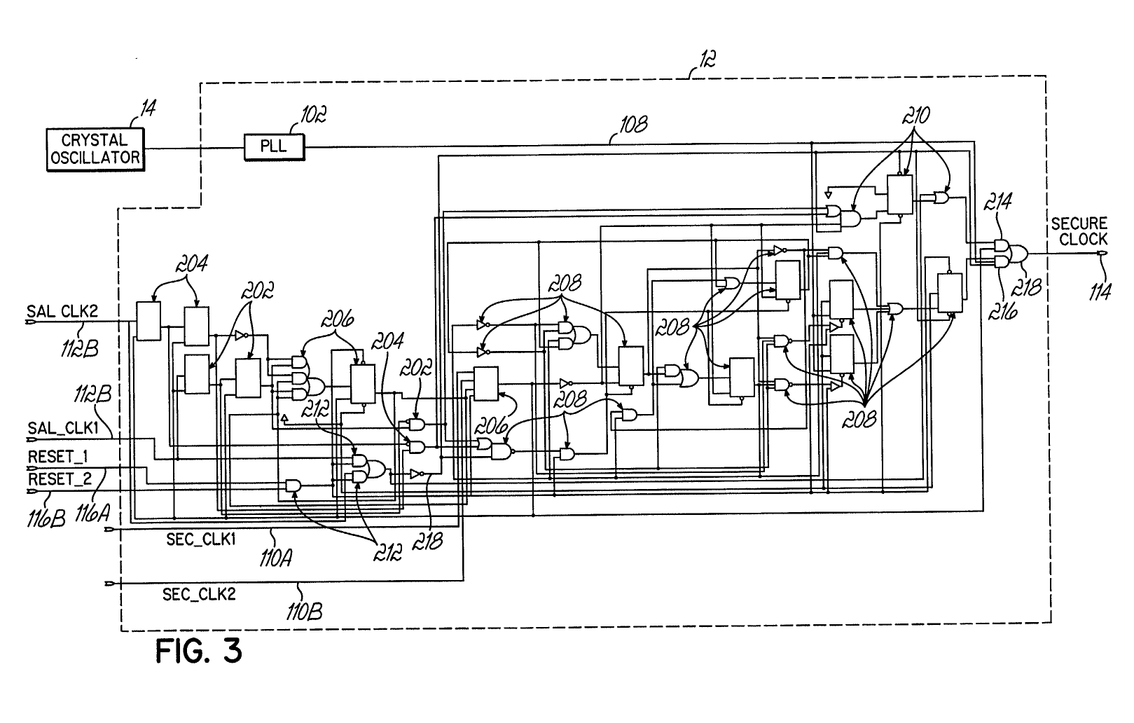

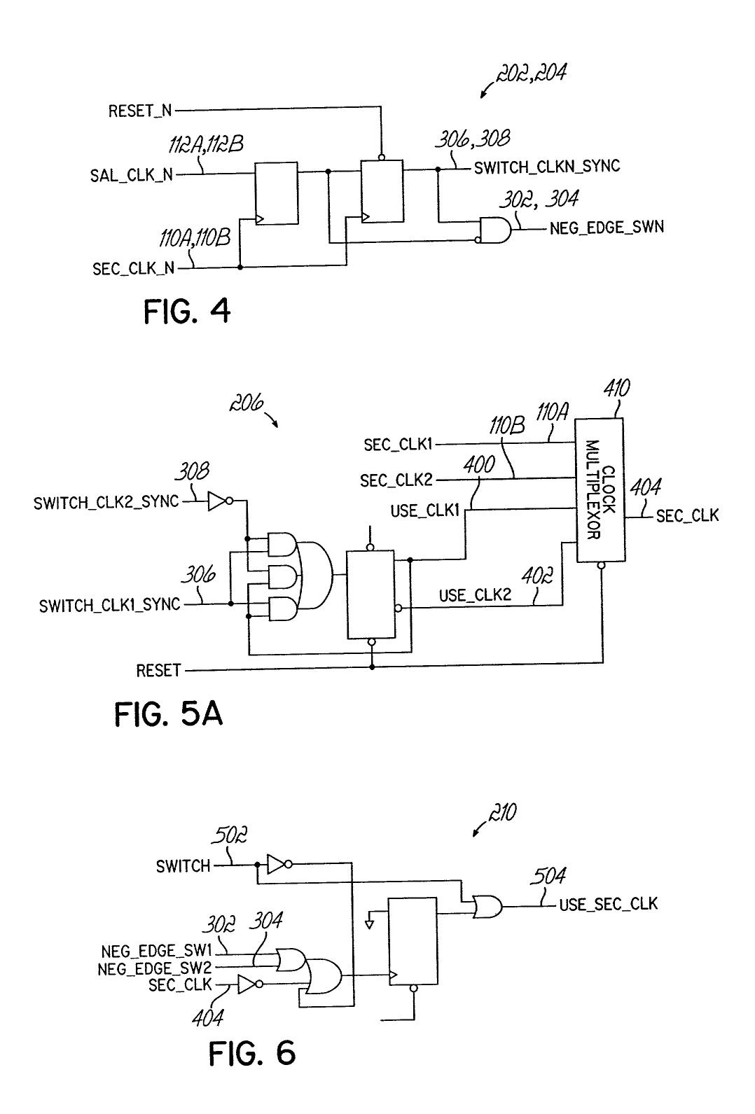

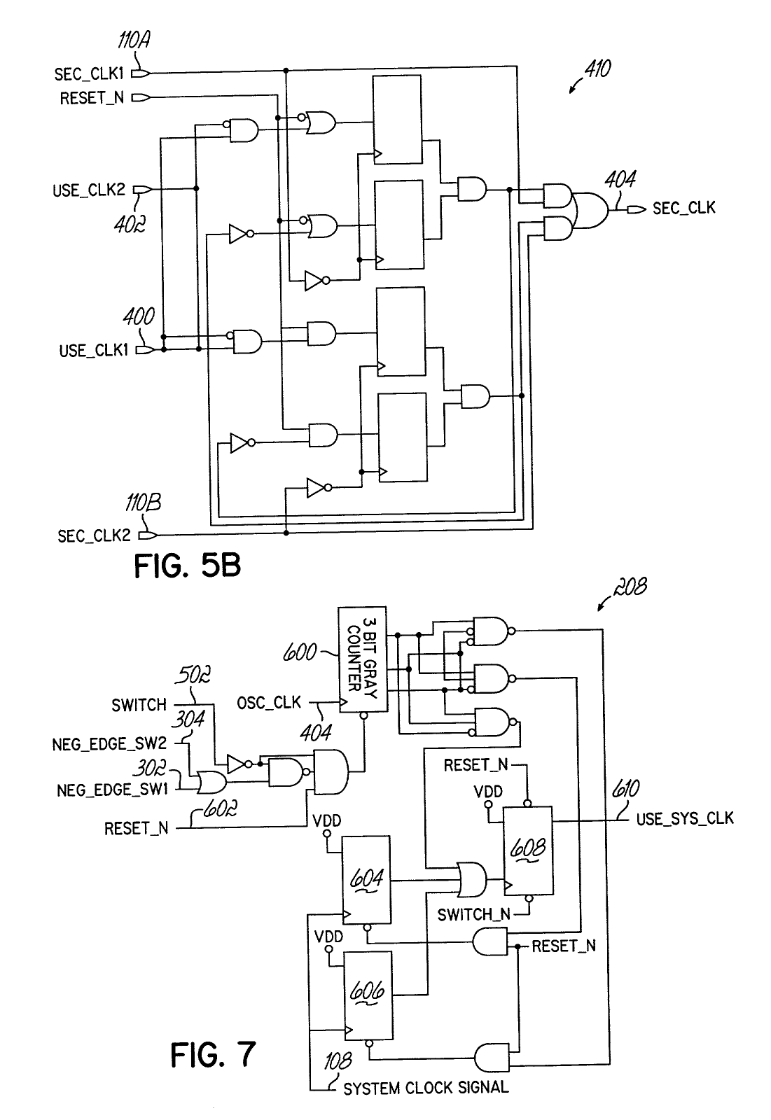

Turning to FIG. 3, one possible circuit for the function block diagram of the clock switch 100 shown in FIG. 2 is illustrated. This is but one possible circuit for an implementation of a clock switch 100 in accordance with the principles of the invention. Referring specifically to FIG. 3, the circuit depicted is composed of the following subcircuits: negative edge switch_1 (202), negative edge switch_2 (204), oscillator clock multiplexor 206, system clock selector 208, and secure clock selector 210. Negative edge switch_1 (202) and negative edge switch_2 (204) are shown in greater detail in FIG. 4. Oscillator clock multiplexor 206 is shown in greater detail in FIGS. 5A and 5B and secure clock selector 210 is shown in greater detail in FIG. 6. System clock selector (208) is shown in FIG. 7. The basic features and operation of each of these subcircuits will be discussed hereinafter in conjunction with their respective Figures.

Turning now to the basic operation of the circuit shown in FIG. 3. The operation of the circuit shown in FIG. 3 is best explained by examining two scenarios. The first scenario is when an over-frequency or under-frequency condition has not been detected by either of the clock monitors 16A, 16B and the clock signal 114 is provided by the system clock signal 108. The second scenario is when an over-frequency or under-frequency condition, or some other fault or security breach in the system, has been detected by one or both of the clock monitors 16A,16B and the secure clock is provided by one of the secure clock signal SEC_CLK1 (110A), SEC_CLK2 (110B) generated by the clock monitors 16A, 16B.

In the first scenario, once the power on sequence has been accomplished, signals RESET 1 (116A) and RESET 2 (116B) are false. Since neither of the clock monitors 16A, 16B has yet detected an over-frequency or under-frequency condition, signals SAL_CLK1 (112A) and SAL_CLK2 (112B) are low. The system clock 12 allows the system clock signal 108 to be output as the secure clock 114.

In the second scenario, one or both of the clock monitors 16A,16B have detected a fault, such as a security attack including an over-frequency or under-frequency condition and the monitors have asserted their respective SAL_CLK1 (112A) or SAL_CLK2 (112B) signals by taking their respective signal to the high state. In this situation, the secure clock signals SEC_CLK1 (110A), SEC_CLK2 (110B) associated with the clock monitor 16A, 16B, which first detected the over-frequency or under-frequency condition, will be output as the secure clock 114. If the remaining clock monitor 16A, 16B were to also detect the fault, such as an over-frequency or under-frequency condition and assert its respective SAL_CLK1 (112A) or SAL_CLK2 (112B) signal, the signal from the second clock monitor would essentially not be used. However, if the first clock monitor no longer detects an over-frequency or under-frequency condition and de-asserts its respective SAL_CLK1 (112A) or SAL_CLK2 (112B) signal, the secure clock SEC_CLK1 (110A), SEC_CLK2 (110B) associated with that clock monitor 16A, 16B, which was second or last to detect the over-frequency or under-frequency condition, would be output as the secure clock signal 114. Provisions are also made for when both clock monitors detect an over-frequency or under-frequency condition simultaneously. In this situation, the system clock 12 defaults to the first clock monitor 16A and its secure clock SEC_CLK1 (110A) is used as the secure clock signal 114. Finally, once both clock monitors 16A, 16B no longer detect an over-frequency or under-frequency condition and no longer assert their respective SAL_CLK1 (112A) and SAL_CLK2 (112B) signals, the system clock 12, once again, outputs the system clock signal 108 as the clock signal 114.

As such, the system clock 12 allows the processor 20 to operate using one of the secure clocks SEC_CLK1 (110A), SEC_CLK2 (110B) in the clock monitors 16A, 16B during an over-frequency or under-frequency security attack. This allows the processor 20 to avoid manipulation of the system clock signal 108 used to step the processor through its operational routines. By doing this, the system clock 12 provides additional security for the ASIC 10.

In this particular embodiment of the present invention, the switching from system clock signal 108 to either secure clock SEC_CLK1 (110A), SEC_CLK2 (110B) within the clock monitors 16A, 16B need not be “clean” since the clock monitors 16A, 16B provide a concurrent reset (RESET 1, RESET 2) 116A, 116B. This concurrent reset is applied in the clock switch 100 through logic gates 212, 216 shown in FIG. 3. However, when switching from either secure clock SEC_CLK (110A), SEC_CLK2 (110B) within the clock monitors 16A, 16B back to the system clock signal 108, the transition must be “clean,” without glitches, extra edges, or narrow pulses, as required by the Philips Semiconductors' ARM720T processor 20 in this disclosed invention embodiment. The embodiment disclosed herein provides this “clean” switching. As will be apparent to one of ordinary skill in the art, if an embodiment of the present invention were to be implemented using clock monitors that did not provide a concurrent reset to the clean switching logic when moving from the system clock to a secure clock, then the clean switching logic could be readily modified to accommodate for clean switching in that scenario as well.

Further, as previously noted, in this particular embodiment no restriction is placed on the low time of the system clock signal 108 or either secure clock SEC_CLK1 (110A), SEC_CLK2 110B in the clock monitors 16A, 16B, so long as the low frequency minimum is not violated. The disclosed embodiment of the present invention might be adapted should it be desirable to used with devices that require a maximum high time between the system clock signal 108 and secure clock signals SEC_CLK1 (110A), SEC_CLK2 (110B). It will be apparent to one of ordinary skill in the art how to modify the clean switching logic 106 to provide minimum low times or maximum high times of the clock signals using known circuitry.

The clean switching logic 106 illustrated allows the multiplexor 104 to switch from either secure clock SEC_CLK1 (110A), SEC_CLK2 (110B) to the system clock signal 108 even if the system clock signal 108 has stopped. That is, the disclosed embodiment of the present invention does not provide for an alternative clock signal in the event of a loss of the system clock signal 108. However, the clean switching logic 106 could be adapted to provide the processor 20 with one of the secure clocks SEC_CLK1 (110A), SEC_CLK2 (110B) if the system clock signal has stopped, should this be desirable.

Finally, the clock monitors 16A, 16B described above utilize known circuitry for determining over-frequency or under-frequency conditions. Further, a person of ordinary skill in the art could readily implement a variety of circuits which provide the same or similar functionality to provide monitoring for a variety of common faults or security attacks, as hereinbefore mentioned. The clock monitors 16A, 16B are represented as functional blocks for illustrating how a system clock 12 could be configured to detect that a system clock signal 108 is out of tolerance and cause a processor 20 to use an alternative secure clock SEC_CLK1 (110A), SEC_CLK2 (110B).

Focusing now on the remaining FIGS., the circuits illustrated show in more detail how the clean switching logic of the present invention is implemented in this particular embodiment of the invention described hereinbefore. FIG. 4 illustrates the logic circuit used for both negative edge switch_1 (202) and negative edge switch_2 (204) shown in FIG. 3. As one skilled in the art will note, the letter “N” denotes specific references to the previously discussed clock monitors 16A, 16B. The negative edge switches 202, 204 function to detect the negative going edges of the SAL_CLK_N 112A, 112B signals from the clock monitors 16A, 16B while also being driven by the SEC_CLK 404. The negative edge switches 202, 204 then output the detected negative edges as signals NEG_EDG_SWN 302, 304, respectively, which are used by subsequent circuits in the following FIGS. The negative edge switches 202, 204 also generate a synchronized version of the SAL_CLK_N 112A, 112B signals and output them as SWITCH_CLKN_SYNC 306, 308. This is the first step in synchronizing the signals necessary to provide clean switching when switching from the system clock signal 108 to one of the secure clocks SEC_CLK1 (110A), SEC_CLK2 (110B) once a fault or security attack, such as an over-frequency or under-frequency condition has been detected by one of the clock monitors 16A, 16B.

Referring now to FIG. 5A, the logic circuit depicted shows a portion of oscillator clock multiplexor 206 shown in FIG. 3. The oscillator clock multiplexor logic circuit takes the SWITCH_CLK1 _SYNC 306 and SWITCH_CLK2_SYNC 308 from the negative edge switches, 202, 204 and determines whether to use SEC_CLK1 (110A) or SEC_CLK2 (110B) as the secure clock SEC_CLK 404 signal. As shown, signals USE_CLK1 (402) and USE_CLK2 (404) are generated to cause the clock multiplexor 410 to select the corresponding clock 110A, 110B for that clock monitor 16A, 16B which has detected an over-frequency or under-frequency condition. This is the second step in synchronizing the signals necessary to provide clean switching when switching from the system clock signal 108 to one of the secure clocks SEC_CLK1 (110A), SEC_CLK2 (110B) once an over-frequency or under-frequency condition has been detected.

Referring now to FIG. 5B, a logic circuit is depicted which performs the functionality described hereinbefore for the clock multiplexor 410 shown in FIG. 5A. One skilled in the art will appreciate that a variety of circuits could also be used to perform the aforementioned multiplexer functionality and that the logic circuit depicted in FIG. 5B is but one such example.

Referring now to FIG. 6, a logic circuit for the secure clock selector 210 shown in FIG. 3 is depicted. The secure clock selector 210 takes its inputs from the negative edges switches 202,204 NEG_EDGE_SW1 302 and NEG_EDGE_SW2 304 signals, the secure clock multiplexor 206 SEC_CLK 404 signal, and the SWITCH 502 signal derived from the SAL_CLK1 (110A) and SAL_CLK2 (110B) by logic gates 212 shown in FIG. 3. Thus, upon assertion of the signal SWITCH 502, the secure clock selector 210 outputs USE_SEC_CLK 504 when an over-frequency or under-frequency condition has been detected. This is the third step in synchronizing the signals necessary to provide clean switching from the system clock signal 108 to one of the secure clocks SEC_CLK1 (110A), SEC_CLK2 (110B) found in the clock monitors 16A, 16B.

Finally, the SEC_CLK 404 signal generated by the clock multiplexor 410 shown in FIG. 5A and the USE_SEC_CLK 504 signal generated by the secure clock selector 210 shown in FIG. 6 are combined in logic gate 214 in FIG. 3 to cause logic gate 218, also shown in FIG. 3, to output the respective secure clock SEC_CLK1 (110A), SEC_CLK2 (110B) for that clock monitor 16A, 16B which detected the over-frequency or under-frequency condition as the secure clock 114. Again, this allows the processor 20 to operate using one of the secure clocks SEC_CLK1 (110A), SEC_CLK2 (110B) in the clock monitors 16A, 16B during an over-frequency or under-frequency fault or security attack and avoid manipulation of the system clock signal 108 in stepping through its operational routines.

Referring now to FIG. 7, a logic circuit for the system clock selector 208 shown in FIG. 3 is depicted. The system clock selector 208 is operative to provide “clean” switching when the processor 20 transitions from operating in conjunction with one of the secure clocks SEC_CLK1 (110A), SEC_CLK2 (110B) in the clock monitors 16A, 16B to operating in conjunction with the system clock signal 108 once a fault or security attack is no longer detected by the clock monitors 16A, 16B. The system clock selector 208 takes as its inputs the NEG_EDGE_SW1 (302) and NEG_EDGE_SW2 (304) signals from the negative edges switches 202, 204 shown in FIG. 4, the SWITCH 502 signal derived from the SAL_CLK1 (110A) and SAL_CLK2 (110B) by logic gates 212 shown in FIG. 3, the RESET_N 602 signal also derived from the RESET_1 and RESET_2 signals by logic gates 212, and the SEC_CLK 404 signal shown in FIGS. 5A and 5B. As shown in FIG. 7, a 3 Bit Grey Counter 600 is held in reset until the negative edge of the last switch is seen from inputs: SWITCH 502, NEG_EDGE_SW2 (304), NEG_EDGE_SW1 (302), and RESET_N 602. The 3 Bit Grey Counter 600 then starts counting, arming a first flip-flop 606 at binary count 1 and a second flip-flop 604 at binary count 3. If the system clock signal 108 is operational, the flip-flops 604, 606 will be clocked. The flip-flops 604, 606, in turn, clock a third flip-flop 608 which asserts the USE_SYS_CLK 610 signal. This enables the USE_SYS_CLK 610 on a rising edge of the system clock signal 108 after the SWITCH 502 signal has been de-asserted and a negative edge of either of signals NEG_EDGE_SW1 (302) or NEG_EDGE_SW2 (304) has been detected. The USE_SYS_CLK 610 is then combined with the SWITCH_N 218 signal derived from the SWITCH 502 signal as shown in FIG. 3 and the system clock signal 108 in logic gate 216. Logic gate 216 then drives logic gate 218 with the system clock signal 108. which is output as the secure clock signal 114, also shown in FIG. 3. This provides clean switching for the processor 20 when switching from operating off of one of the secure clocks SEC_CLK1 (110A), SEC_CLK2 (110B) in the clock monitors 16A, 16B to the system clock signal 108 once an over-frequency or under-frequency is no longer detected. It should also be noted, as previously pointed out, that even if the system clock signal 108 is not operating, the secure clock 114 shown in FIGS. 2 and 3 will still be switched to the system clock signal 108 after the 3 Bit Gray Counter 600 times out.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A method for enhancing the security of a system operating in conjunction with a clock signal from a system clock, comprising:
monitoring the system for detecting a fault in the system;
upon detection of a fault, switching the system from operating in conjunction with a clock signal from the system clock to operate in conjunction with a secure clock signal from a secure clock.

2. The method of claim 1, wherein the system is switched to operate in conjunction with a secure clock signal from one of a plurality of secure clocks.

3. The method of claim 1, further comprising:
monitoring the system operating in conjunction with a clock signal from a secure clock,
upon detecting cessation of said fault in the system, switching the system to again operate in conjunction with a clock signal from the system clock.

4. The method of claim 3, further comprising switching the system back to the clock signal from the system clock even if the system clock is not operating.

5. The method of claim 1 further comprising monitoring the system for detecting a fault associated with one of an over-frequency and under-frequency clock signals from the system clock.

6. The method of claim 1, further comprising:
when switching the system to operate in conjunction with the secure clock signal from the secure clock, preventing the clock signal from having short transitions that do not cross the logic threshold from a high to low state or a low to high state.

7. The method of claim 1, wherein when switching from the clock signal of the system clock to the secure clock signal of the secure clock, the clock signal has an extend low time.

8. The method of claim 1 further comprising multiplexing together clock signals from the system clock and from at least one secure clock and, upon detecting a fault, selecting one of the multiplexed clock signals for operating the system.

9. The method of claim 3 further comprising, when switching between clock signals, waiting until the clock signal, which is being switched from, transitions to a low state.

10. An apparatus for enhancing the security of a system operating in conjunction with a clock signal from a system clock, the apparatus comprising:
a secure clock generating a secure clock signal;
a clock monitor circuit configured to monitor the system for detecting a fault;
clock switching circuitry, the clock switching circuitry operably coupled to the clock monitor circuit, the system clock signal and the secure clock signal;
the clock switching circuitry configured, upon the detection of a fault, to switch the system from operating in conjunction with a clock signal from the system clock to operate in conjunction with a secure clock signal from a secure clock.

11. The apparatus of claim 10, further comprising:
a plurality of secure clocks with secure clock signals;
the clock switching circuitry operably coupled to plurality of secure clock signals for switching the system to operate in conjunction with one of the secure clock signals.

12. The apparatus of claim 10, wherein the secure clock includes a ring oscillator.

13. The apparatus of claim 10, wherein the clock monitor circuit is configured to detect the cessation of the detected fault;
the clock switching circuitry further configured to switch the system to again operate in conjunction with a clock signal from the system clock upon detecting the cessation of said fault.

14. The apparatus of claim 10 wherein the clock monitor circuit is configured to monitor the system for detecting a fault associated with one of an over-frequency and under-frequency clock signals from the system clock, the clock switching circuitry configured to switch the system to operate in conjunction with a secure clock signal from a secure clock to prevent over-frequency and under-frequency clocking of the system.

15. The apparatus of claim 14 wherein the clock monitor circuit includes frequency dividers; and, delay lines, the frequency dividers and delay lines configured to detect over-frequency and under-frequency clock signals from the system clock.

16. An application specific integrated circuit comprising:
a processor;
a clock generating a system clock signal for operation of the processor;
the secure clock further generating a secure clock signal;
a clock monitor circuit configured to monitor the application specific integrated circuit for detecting a fault;
clock switching circuitry, the clock switching circuitry operably coupled to the clock monitor circuit, the system clock signal and the secure clock signal;
the clock switching circuitry configured, upon the detection of a fault, to switch the processor from operating in conjunction with a system clock signal to operating in conjunction with the secure clock signal.

17. The circuit of claim 16, further comprising:
a plurality of secure clocks with secure clock signals;
the clock switching circuitry operably coupled to plurality of secure clock signals for switching the system to operate in conjunction with one of the secure clock signals.

18. The circuit of claim 16, wherein the clock monitor circuit is configured to detect the cessation of the detected fault;
the clock switching circuitry further configured to switch the processor to again operate in conjunction with the system clock signal upon detecting the cessation of said fault.

19. The circuit of claim 16 wherein the clock monitor circuit is configured to monitor the circuit for detecting a fault associated with one of an over-frequency and under-frequency system clock signal, the clock switching circuitry configured to switch the processor to operate in conjunction with a secure clock signal from a secure clock to prevent over-frequency and under-frequency clocking of the processor.
